(19) United States
(12) Patent Application Publication
(10) Pub. No.: US 2007/0233755 A1
(43) Pub. Date: Oct. 4, 2007

(54) APPARATUS, COMPUTER PROGRAM PRODUCT, AND METHOD FOR DISPLAYING DATA

(75) Inventor: Yasutaka Ohdake, Kanagawa (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/689,103

(22) Filed: Mar. 21, 2007

(30) Foreign Application Priority Data
Mar. 29, 2006 (JP) 2006-091994

(51) Int. Cl. G06F 17/30

(52) U.S. Cl. 707/203

(57) ABSTRACT

A data displaying apparatus includes a displaying unit that, when a search result contains an instance data generated based on an old version of a dictionary, displays the instance data generated based on the old version of the dictionary in a display mode that is different from the display mode in which the instance data generated based on a new version of the dictionary is displayed, according to an updated attribute extracted by an updated-attribute extracting unit and a display mode rule managed by a display-mode-rule managing unit.

### CROSS-REFERENCE TO RELATED APPLICATIONS

This application is based upon and claims the benefit of priority from the prior Japanese Patent Application No. 2006-091994, filed on Mar. 29, 2006; the entire contents of which are incorporated herein by reference.

### BACKGROUND OF THE INVENTION

1. Field of the Invention

The present invention relates to an apparatus, a computer program product, and a method for displaying data.

2. Description of the Related Art

A hierarchical database such as an object-oriented database (OODB) or an object-relational database (ORDB) has a hierarchical structure in which subordinate categories inherit the properties of their superordinate categories. In such a hierarchical database, because the properties are inherited, the number of properties progressively increases in the subordinate categories.

In an object-oriented database, each category in the hierarchical levels is often referred to as a “class”. On the other hand, in an object-relational database (ORDB), a table allowed to be inherited corresponds to the classes. Between tables that have a superordinate-subordinate relationship, properties are inherited from a superordinate table to a subordinate table; in other words, header information of columns in the superordinate table is inherited to the subordinate table. Data that has a property species in common and belongs to a category in a hierarchical level is referred to as an “instance”. A set of instances is referred to as a “population” of data.

An example of such a hierarchical database is seen in International Organization for Standardization (ISO) 13584 Parts Library Standard (hereinafter, “the PLIB Standard”), which is an international standard for implementing an electronic catalog system that electronically provides product information. The PLIB Standard is an international standard that defines an object-oriented description method and semantics in an exchange file format that are related to product or part library data that is made up of a plurality of “parts” such as Part 1, 2, and so on; in other words, the PLIB Standard defines what terms, what description method, and what data pattern are used. Part 42 of the PLIB Standard shares the same contents as the International Electrotechnical Commission (IEC) 61360-2 (Part 2). IEC 61360-2 (Part 2) is a system that categorizes products in an object-oriented manner, defines the properties with which each category is characterized, and exchanges files containing the contents of the categories. Thus, needless to say, the concept of inheriting the properties is included in the IEC standard.

The PLIB Standard defines not only an information model of dictionaries but also a method for managing versions of the dictionaries when the dictionaries are revised. For example, the PLIB Standard defines that the version number of a property is incremented by one, when the value of a “name” has been changed, the “name” being one of attributes that are each a detailed information field of the property (in other words, each attribute defines the characteristic of the property).

Also, when one or more attributes have been changed, in other words, when a dictionary has been revised, the instances generated according to the dictionary also need to be updated.

In an electronic catalog management system disclosed in JP-A 2005-018294 (KOKAI), a technique is proposed by which mutually-different unit systems in product part information data provided by the PLIB are unified by automatically converting the unit systems to a unit system written in a dictionary on the user side. By implementing the technique disclosed in this KOKAI, when the attribute “unit” of one of properties in a dictionary has been changed, it is possible to change instances in accordance with the revision of the dictionary.

Generally, in an electronic catalog service for electronic parts or the like, the dictionary is updated frequently. In other words, an instance editor on the part information supplier side is required to change the instances almost at the same time as a revision of the dictionary.

In actuality, however, because of increases in the number of kinds of parts/the number of instances, a problem arises where it is difficult for the instance editor to update the instances all at once so as to make the instances comply with a new dictionary. In other words, the update of the instance information cannot keep up with the frequency with which the dictionary is updated.

When a dictionary has been updated, only a few properties in a class are actually affected. However, in the present situation, all the instances need to be rewritten despite of changes in the small number of properties. This situation is one of the reasons why the instance editor is kept busy with inefficient work.

In addition, as disclosed in JP-A 2005-018294 (KOKAI), when instances written according to an old dictionary are automatically converted into instances according to a new dictionary, another problem arises in terms of reliability of the data.

### SUMMARY OF THE INVENTION

According to one aspect of the present invention, a data displaying apparatus includes an instance data managing unit that manages an old version of an instance data and a new version of the instance data that are respectively generated based on an old version of a dictionary and a new version of the dictionary, the dictionary having the old and the new versions due to a change in a property, the attribute being detailed information field defining a characteristic of the property; an updated-attribute extracting unit that extracts an updated attribute resulting from an update of an attribute between the old version of the dictionary and the new version of the dictionary; a display-mode-rule managing unit that manages a display mode rule defining so that a display mode for the old version of the instance data is different from a display mode for the new version of the instance data, according to the updated attribute; a searching unit that searches the instance data according to a search request, the instance data generated based on the old version of the dictionary; and a displaying unit that displays the instance data in the display mode that is different from the display mode in which the instance data generated based on the new version of the dictionary is displayed, according to the updated attribute extracted by the updated-attribute extracting unit and the display mode rule managed by the display-mode-rule managing unit.

According to another aspect of the present invention, a data search displaying method includes accepting an input of an instance data that is specific information of a property and is written according to a dictionary; managing an old version of the instance data and a new version of the instance data that are input and respectively generated based on an old version of the dictionary and a new version of the dictionary, the dictionary having the old and the new versions due to a change in the property, the attribute being detailed information field defining a characteristic of the property; extracting an updated attribute resulting from an update of an attribute between the old version of the dictionary and the new version of the dictionary; managing a display mode rule defining that a display mode for the old version of the instance data is different from a display mode for the new version of the instance data, according to the updated attribute; accepting an input of a search request for a search through the instance data; searching the instance data according to the input search request, the instance data generated based on the old version of the dictionary; and displaying the instance data in the display mode that is different from the display mode in which the instance data generated based on the new version of the dictionary is displayed, according to the extracted updated attribute and the managed display mode rule.

A computer program product according to still another aspect of the present invention causes a computer to perform the method according to the present invention.

### BRIEF DESCRIPTION OF THE DRAWINGS

FIG. 1 is a schematic view of an example of a system construction for a data search-displaying system according to a first embodiment of the present invention;

FIG. 2 is a module structure diagram of a server and a client terminal;

FIG. 3 is a functional block diagram of a data search-displaying system;

FIG. 4 is a schematic view of an example of a dictionary stored in a hierarchical database;

FIG. 5 is a schematic view of examples of instances according to the dictionary shown in FIG. 4;

FIG. 6 is a schematic view of an example of an update of a dictionary performed by applying changes to attributes in the dictionary shown in FIG. 4;

FIG. 7 is a schematic view of examples of differences (updated attributes) between an old version of a dictionary and a new version of a dictionary;

FIG. 8 is a schematic view for explaining a carry-over of instances performed when a dictionary is updated;

FIG. 9 is a schematic view of a display mode rule;

FIG. 10 is a schematic view of an example of a search result;

FIG. 11 is a flowchart of a procedure in a display method judging process performed by a search-result output unit;

FIG. 12 is a flowchart of a procedure in a judging process performed by a display judging unit;

FIG. 13 is a front view of an example in which a result to which the display judging process has been applied is displayed;

FIG. 14 is a front view of an example in which attributes of a property defined according to an old version of a dictionary are displayed in a balloon;

FIG. 15 is a front view of an example in which an attribute of a property defined according to a new version of a dictionary is displayed in a balloon;

FIG. 16 is a functional block diagram of a data search-displaying system according to a second embodiment;

FIG. 17 is a schematic view of display mode rules for realizing an automatic conversion;

FIG. 18 is a front view of an example in which a value obtained after an automatic conversion is presented in a pop-up window;

FIG. 19 is a functional block diagram of a data search-displaying system according to a third embodiment;

FIG. 20 is a front view of an example in which a notification to prompt an update is displayed together; and

FIG. 21 is a front view of a state obtained after instances are edited in response to the notification to prompt an update.

### DETAILED DESCRIPTION OF THE INVENTION

Exemplary embodiments of an apparatus, a computer program product, and a method for displaying data according to the present invention will be explained in detail, with reference to the accompanying drawings.

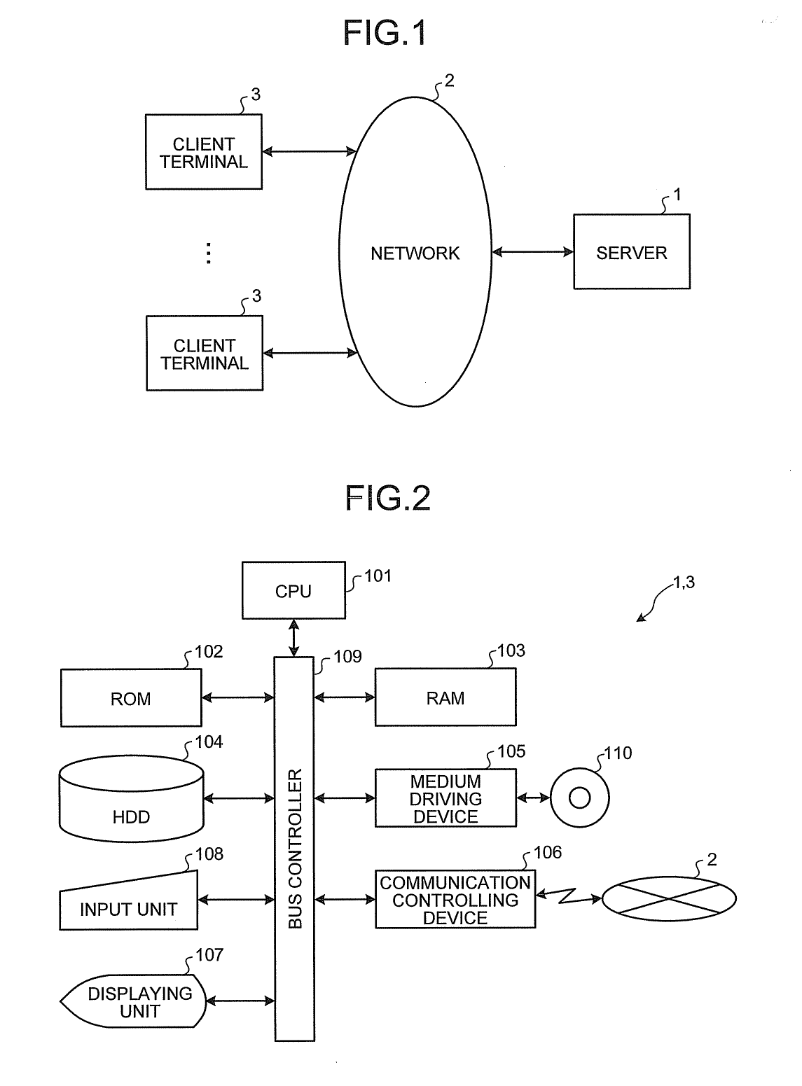

A first embodiment will be explained with reference to FIGS. 1 to 15.

A data search-displaying system shown in FIG. 1 is assumed to be a server-client system in which a plurality of client computers (hereinafter, “client terminals”) 3 are connected to a server computer (hereinafter, a “server”) 1 via a network 2 such as a Local Area Network (LAN). Each of the client terminals 3 is a commonly-used personal computer or the like.

As shown in FIG. 2, each of the server 1 and the client terminals 3 is configured so as to include: a Central Processing Unit (CPU) 101 that performs information processing; a Read Only Memory (ROM) 102 that stores therein a Basic Input/Output System (BIOS) and the like; a Random Access Memory (RAM) 103 that stores therein various kinds of data in a rewritable manner; a Hard Disk Drive (HDD) 104 that functions as various types of databases and also stores therein various kinds of programs; a medium driving device 105 such as a Compact Disk Read Only Memory (CD-ROM) drive that stores information into a storage medium 110 and distributes and obtains information to and from the outside of the server 1 or the client terminal 3 via the storage medium 110; a communication controlling device 106 that exchanges information with other computers on the outside of the server 1 or the client terminal 3 through communication via the network 2, a displaying unit 107 such as a Cathode Ray Tube (CRT) display or a Liquid Crystal Display (LDC) that displays the progress or a result of a process; and an input unit 108 that is a pointing device such as a keyboard or a mouse used by an operator for inputting instructions and information to the CPU 101. During the operation of the server 1 or the client terminals 3, the data transmitted and received to and from these constituent elements is reconciled by a bus controller 109.

In each of the server 1 and the client terminals 3, when the operator turns on the electric power, the CPU 101 activates a program called a loader stored in the ROM 102, and a program called an Operating System (OS) that manages hardware and software in the computer is read from the HDD 104 into the RAM 103, so that the OS is activated. The OS runs programs and reads or saves information according to the operator's operation. Typical examples of operating systems include Windows (registered trademark) and UNIX (registered trademark). Operation programs that run on such an OS are called application programs. Application programs, however, are not limited to those that operate on a predetermined OS. Application programs may include those that cause an OS to act as a substitute in executing a part of various types of processes described below and those that are included as a part of a set of program files that structure predetermined application software or an operating system.

The server 1 has a search-displaying process program stored in the HDD 104, as an application program. In this sense, the HDD 104 functions as a storage medium that stores therein the search-displaying process program.

On the other hand, each of the client terminals 3 has an editing process program stored in the HDD 104, as an application program. In this sense, the HDD 104 functions as a storage medium that stores therein the editing process program.

Generally, the application program to be installed onto the HDD 104 in each of the server 1 and the client terminals 3 is previously recorded, as an operation program, on the storage medium 110 that can be any type of optical disk like a CD-ROM or a Digital Versatile Disk (DVD), any type of magnetooptical disk, any type of magnetic disk like a flexible disk, or a medium using any other method like a semiconductor memory, and then, the operation program thus recorded on the storage medium 110 is installed onto the HDD 104. Thus, the storage medium 110 that is portable such as an optical information recording medium like a CD-ROM or a magnetic medium like a Flexible Disk (FD) may serve as a storage medium that stores therein each of the application programs. Furthermore, each of the application programs may be installed onto the HDD 104, after being brought into the server 1 or the client terminals 3 from the outside via, for example, the communication controlling device 106.

In the server 1, when the search-displaying process program that operates on the OS is activated, the CPU 101 performs, according to the search-displaying process program, various types of computation processes so as to control the constituent elements of the server 1 in a centralized manner. On the other hand, in each of the client terminals 3, when the editing process program that operates on the OS is activated, the CPU 101 performs, according to the editing process program, various types of computation processes so as to control the constituent elements of the client terminal 3 in a centralized manner. Of the various types of computation processes that are performed by the CPU 101 in each of the server 1 and the client terminals 3, processes that form the characteristics of the first embodiment will be explained below.

According to the editing process program, each of the client terminals 3 outputs data received from the server 1 to the displaying unit 7 via a Graphic User Interface (GUI), receives, via the GUI, data or a command that is based on an operation or a setting that has been made by an operator on a screen displayed on the displaying unit 107 and has been input via the input unit 108, and sends the received data or command to the server 1. The editing process program exerts its various functions according to the operator's authority. As described in detail later, by operating according to the editing process program, each of the client terminals 3 according to the first embodiment functions as a searcher terminal (i.e., a search-request input unit) that is used by a searcher and accepts an input of a search request for a search through instances, a dictionary editor terminal that is used by a dictionary editor, and an instance editor terminal (i.e., an instance input unit) that is used by an instance editor on the part information supplier side and accepts an input of an instance.

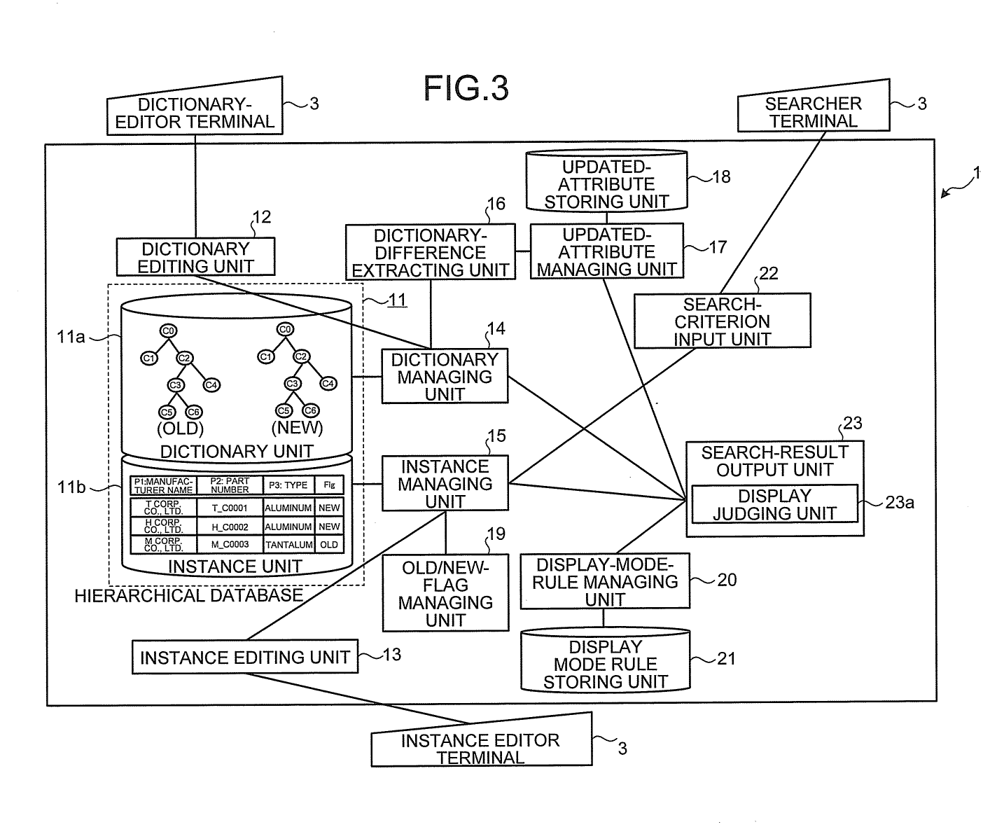

On the other hand, by operating according to the search-displaying process program, the server 1 functions as a data displaying apparatus. As shown in FIG. 3, the server 1 includes a hierarchical database 11, a dictionary editing unit 12, an instance editing unit 13, a dictionary managing unit 14, an instance managing unit 15 that functions as an instance searching unit, a dictionary-difference extracting unit 16, an updated-attribute managing unit 17, an updated-attribute storing unit 18, an old/new-flag managing unit 19, a display-mode-rule managing unit 20, a display-mode-rule storing unit 21, a search-criterion input unit 22, and a search-result output unit 23. The functions of these constituent elements will be explained below.

First, a function used for maintenance and management of the hierarchical database 11 will be explained.

The hierarchical database 11 includes a dictionary unit 11a in which old and new versions of a dictionary (i.e., category systems [classes] and properties with which the categories are characterized) of product parts are stored and an instance unit lib in which specific information of the product parts (hereinafter, “instance”) that is written according to the dictionary is stored. Instance is not an abstract concept but concrete data. In other words, the hierarchical database 11 functions as an instance managing unit.

The dictionary editing unit 12 has a function of registering a dictionary that has been input by a dictionary editor using the client terminal 3 serving as the dictionary editor terminal, into the dictionary unit 11a included in the hierarchical database 11. The instance editing unit 13 has a function of registering an instance that has been input by an instance editor on the part information supplier side using the client terminal 3 serving as the instance editor terminal, into the instance unit 11b included in the hierarchical database 11.

Information is registered into and searched from the dictionary unit 11a and the instance unit 11b included in the hierarchical database 11 by the dictionary managing unit 14 and the instance managing unit 15, respectively. The management target of the dictionary managing unit 14 is the dictionary that has two or more versions. According to the first embodiment, it is assumed that two versions of the dictionary, namely, an old version of the dictionary and a new version of the dictionary, are dealt with; however, it is possible to perform the process in the same fashion on three or more versions of the dictionary.

The dictionary-difference extracting unit 16 has a function of extracting one or more differences (i.e., updated attributes) between the old version of the dictionary and the new version of the dictionary that are stored in the dictionary unit 11a and managed by the dictionary managing unit 14. In other words, the dictionary-difference extracting unit 16 functions as an updated-attribute extracting unit. For example, the dictionary-difference extracting unit 16 extracts “in what way which attribute of which property has been updated”. The updated-attribute managing unit 17 has a function of managing and storing the differences obtained by the dictionary-difference extracting unit 16 into the updated-attribute storing unit 18 as updated attributes.

The old/new-flag managing unit 19 manages according to which version of the dictionary (i.e., the old version or the new version) in each of the instances is written. More specifically, the old/new-flag managing unit 19 appends a flag (“Flg”) to each of the instances, the flag indicating one of the old and the new versions of the dictionary according to which the instance is written. When an instance is generated or updated, the old/new-flag managing unit 19 manages the instance by rewriting the value of the flag.

The display-mode-rule managing unit 20 has a function of managing and storing a display mode rule into the display-mode-rule storing unit 21. The display mode rule defines in what display mode, the value of each instance should be displayed, according to the types of the updated attributes. It is assumed that the display mode rule is configured, in advance, into the display-mode-rule storing unit 21 via the display-mode-rule managing unit 20 by a system administrator or the like.

The search-criterion input unit 22 receives a search request for a search through the instances stored in the instance unit 11b included in the hierarchical database 11 from the client terminal 3 that functions as a searcher terminal, and forwards a search text in the search request to the instance managing unit 15.

The search-result output unit 23 receives a search result from the instance managing unit 15. If the search result contains an instance written according to the old version of the dictionary, a display judging unit 23a determines how the search result should be displayed, based on information obtained from the updated-attribute managing unit 17 and the display-mode-rule managing unit 20, so that the search-result output unit 23 displays the search result. In other words, the search-result output unit 23 functions as a search-result displaying unit.

Next, the data structures of the dictionary and the instances stored in the hierarchical database 11 will be explained.

First, the data structure of the dictionary stored in the dictionary unit 11a included in the hierarchical database 11 will be explained.

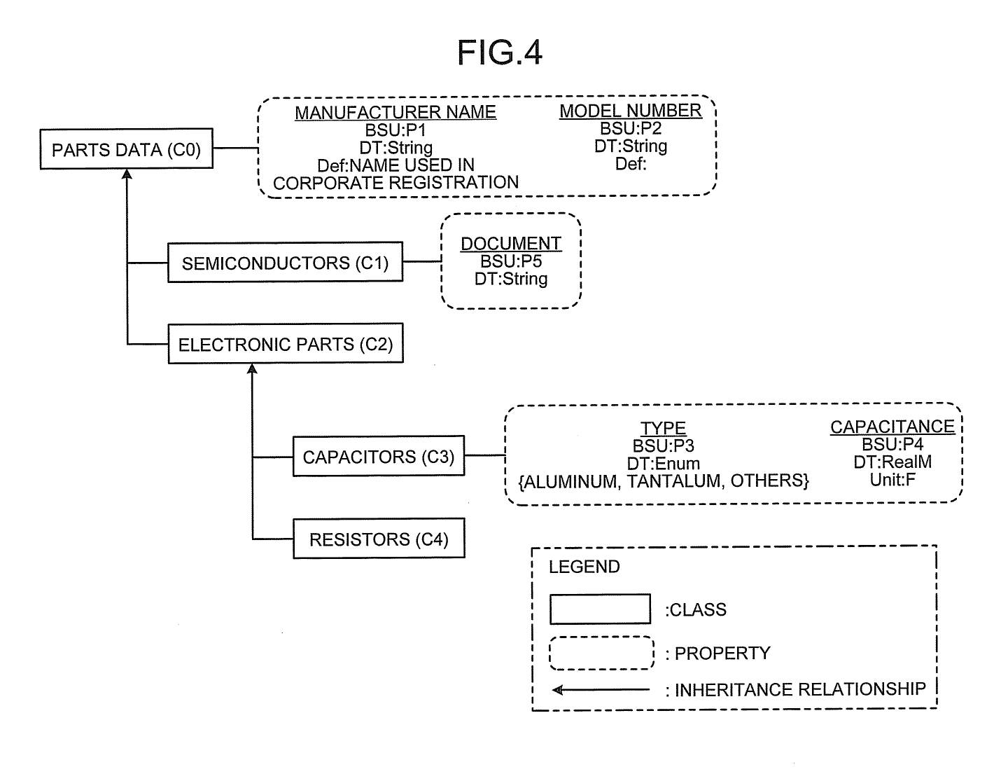

The dictionary shown in FIG. 4 has a hierarchical structure in which the category “parts data” is the root class, and “semiconductors” and “electronic parts” are associated with the root class, as child classes of the root class. In other words, it is indicated that “parts data” can be classified into the two categories of “semiconductors” and “electronic parts”. Similarly, “electronic parts” can be classified into the two categories of “capacitors” and “resistors”. The hierarchical structure may have any number of levels. The symbols in the parentheses (i.e., C0 to C4 in the present example) are codes (hereinafter, “class Basic Semantic Unit [BSU] codes”) that express classes and are uniquely assigned in each dictionary.

As shown in FIG. 4, for each of the classes defining the hierarchical structure, properties (shown with dotted-line boxes in FIG. 4) that are unique to the class are defined. Each class inherits the properties defined for its superordinate class. For example, the property items of the class “capacitors” are the properties defined for its superordinate class “parts data” (namely, “manufacturer name” and “model number”), the properties defined for the class “electronic parts” (none in the present example), and the properties defined for the class “capacitors” (namely, “type” and “capacitance”). Like the codes of the classes, codes (hereinafter, “property BSU codes” or simply “BSU codes”) that express properties and are uniquely assigned in each dictionary are used.

In addition, an attribute that is detailed information field of the class and the property (in other words, each attribute defines the characteristic of the property) is given to each of the properties. Examples of the attributes include the BSU codes themselves and the names such as “manufacturer name”, “model number” themselves. Other examples of the attributes are a data type (DT:), a definition of a property (Def:), and a unit name (Unit:) that is used when the data type is such that has a unit. The attribute items are determined in advance. Examples of predetermined data types (DT:) include a character string type (String), an integer type (Int), a real number type (Real), an integer-with-unit type (IntM), a real-number-with-unit type (RealM), and an enumeration type (Enum). For example, the values of the attributes for the property “capacitance” shown in FIG. 4 are defined as “name:capacitance”, “property BSU code: P4”, “data type: real-number-with-unit type”, and “unit name: F”. The values of the attributes for the property “type” shown in FIG. 4 are defined as “name: type”, “property BSU code: P3”, and “data type: enumeration type (the value can be one of {aluminum, tantalum, and others})”.

One example of a data model that defines the structure of a dictionary including the parent-child structure of the classes, the types of the properties and their attributes, and the kinds of the data types is ISO 13584/Parts Library (PLIB), which is an international standard for an exchange format of product parts library as explained above.

In the description of the first embodiment, an example has been explained in which the present invention is applied to a hierarchical structure database according to the PLIB model. However, the present invention may be applied to any other databases besides the PLIB database. Furthermore, although the first embodiment is explained based on the hierarchical database, the present invention may be applied to a flat database that has no hierarchical levels, as long as the database includes properties that have predetermined attributes.

Next, the data structure of the instances stored in the instance unit 11b included in the hierarchical database 11 will be explained.

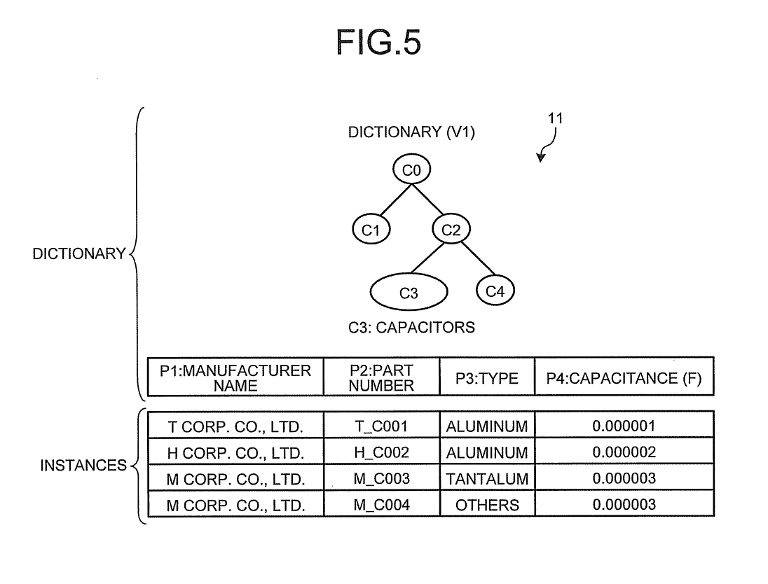

In FIG. 5, the instances that belong to the class “capacitors (C3)” are shown. Each of the instances indicates, for example, the specification information (i.e., an electronic catalog) of the capacitors.

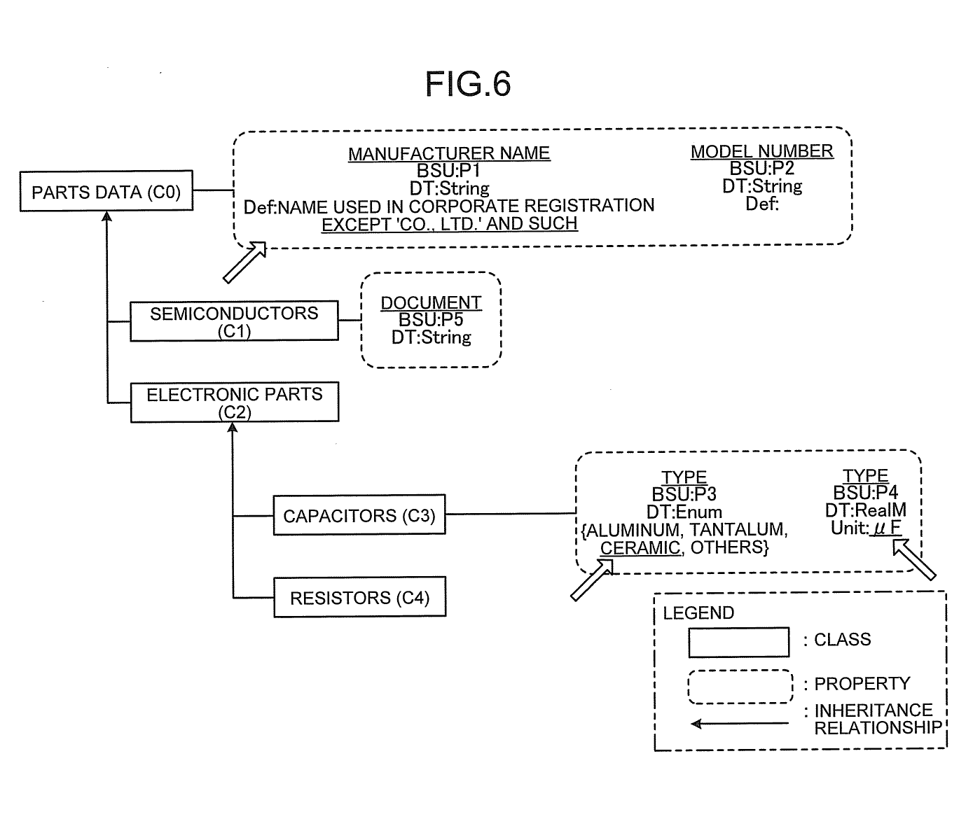

FIG. 6 is a schematic view for explaining an update of a dictionary (indicated with arrows in FIG. 6) by applying changes to the attributes in the dictionary shown in FIG. 4. For the sake of convenience of the explanation, the version of the dictionary shown in FIG. 4 will be referred to as V1, whereas the version of the dictionary shown in FIG. 6 will be referred to as V2. Typical examples of updates of dictionaries include changing the attribute “definition” of a property, changing the attribute “unit”, and adding/deleting one example of the attribute “data type”: “enumeration type”.

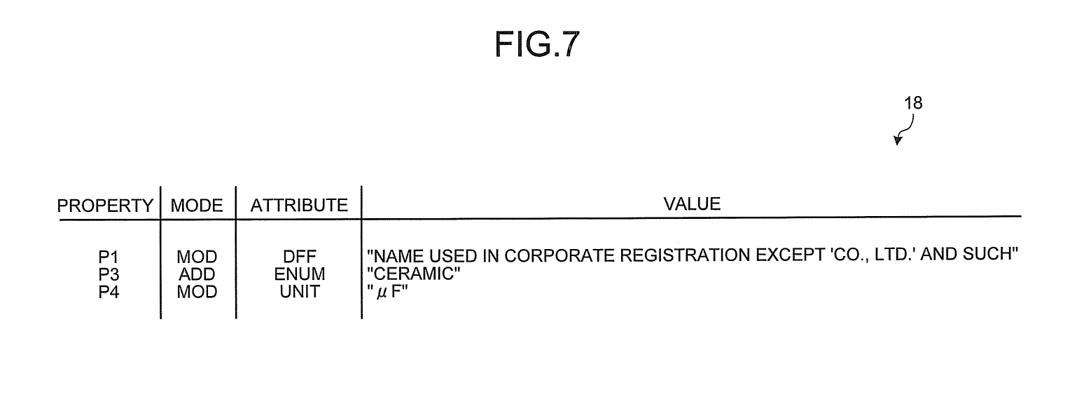

The changes from the dictionary shown in FIG. 4 (i.e., V1) to the dictionary shown in FIG. 6 (i.e., V2), in other words, the differences (i.e., the updated attributes) between the old version of the dictionary and the new version of the dictionary that are extracted by the dictionary-difference extracting unit 16 are shown in FIG. 7. In the updated attributes shown in FIG. 7, the first line indicates that the attribute “definition” (DEF) of the property P1 “manufacturer name” has been modified (MOD) to “the name used in corporate registration except ‘Co., Ltd.’ and such”. The second line indicates that “ceramic” is added (ADD) as an element of the attribute “enumerated values” (ENUM) of the property P3 “type”. Similarly, the third line indicates that the attribute “unit” (UNIT) of the property P4 “capacitance” is modified (MOD) to “μF”.

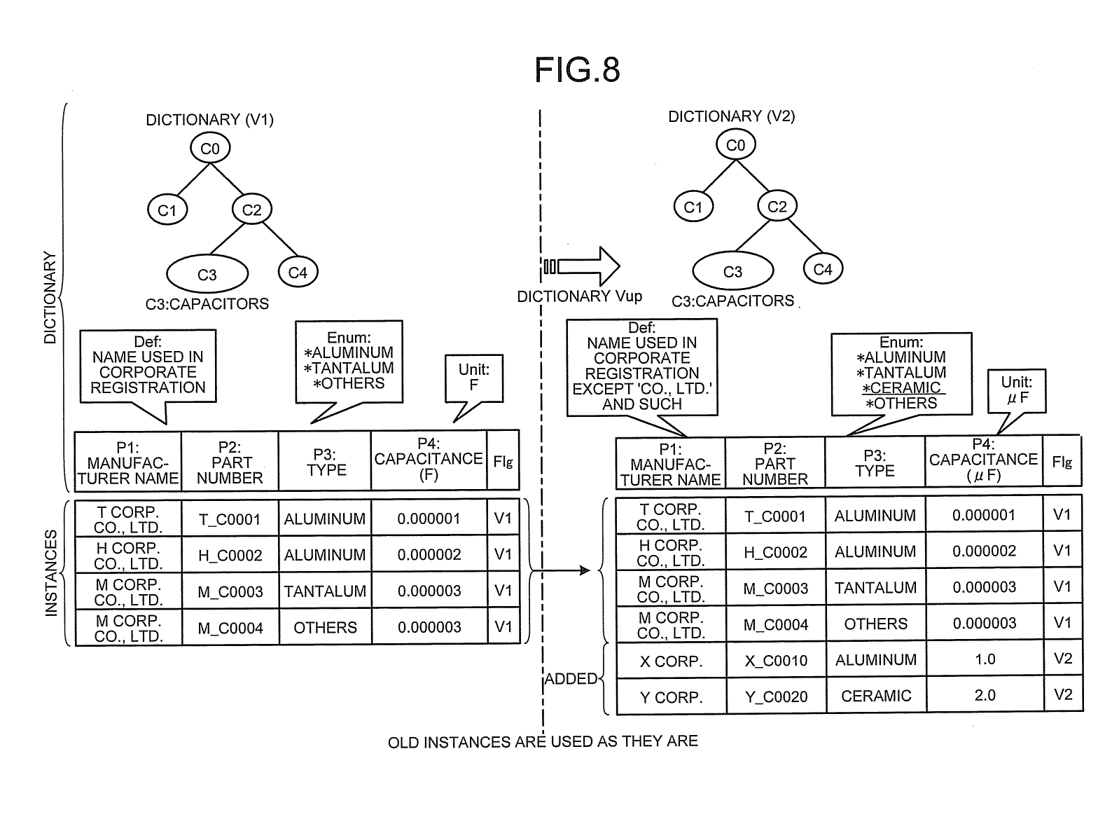

FIG. 8 is a schematic view for explaining the carry-over of the instances when the dictionary is updated. Shown in the column on the right end of each instance is a flag (Flg) that indicates the version of the dictionary according to which the instance has been edited. According to the first embodiment, the value of each of the flags is either V1 or V2 indicating one of the versions of the dictionary. As shown in FIG. 8, when the dictionary is updated from V1 to V2, the values of the instances are carried over as they are. In addition, it is indicated that the instances in the last two lines shown in FIG. 8 that have been added are generated based on the dictionary V2.

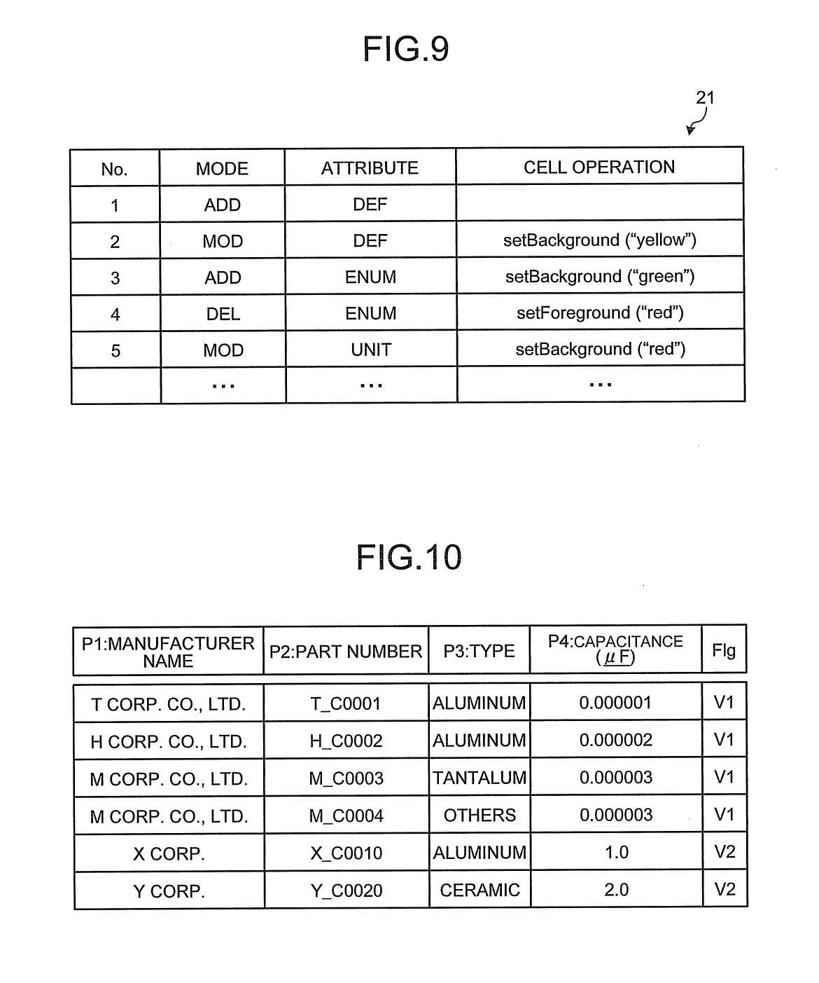

Next, the data structure of the “display mode rule” that determines the display mode for each of the instances will be explained, with reference to FIG. 9. The display mode rule is made up of “mode”, “attribute”, and “cell operation”. The meaning of each line will be explained below.

When a dictionary is updated, if the “attribute” of a property is updated so as to become “mode”, the cell of the target property of each of the instances according to the old version of the dictionary is displayed in the manner defined under “cell operation”. In other words, the instances that are written according to the new version of the dictionary are not affected.

For example, the rule No. 3 means that if there is a property to which an enumerated value has been added when a dictionary is updated, regarding to display the property value in the instances that are written according to the old version of the dictionary, the “background color is set to green (set Background (“green”))”.

Next, a registration management function of the data displaying apparatus achieved by the constituent elements of the server 1 that serves as the data displaying apparatus will be explained.

A dictionary editor uses the client terminal 3 that functions as the dictionary editor terminal and registers the dictionary V1 shown in FIG. 4 into the dictionary unit 11a included in the hierarchical database 11, via the dictionary editing unit 12. An instance editor on the part information supplier side uses the client terminal 3 that functions as the instance editor terminal and registers the instances shown in FIG. 5 into the instance unit 11b included in the hierarchical database 11, via the instance editing unit 13. The dictionary and the instances are managed through the dictionary managing unit 14 and the instance managing unit 15, respectively. Also, a searcher is able to perform searches in the dictionary and the instances.

Next, a situation will be explained in which the system starts being used with an initial state as described above, and subsequently, the dictionary needs to be updated.

The dictionary editor uses the client terminal 3 that functions as the dictionary editor terminal and revises the dictionary V1 via the dictionary editing unit 12. The dictionary obtained after the revision is shown in FIG. 6 and is referred to as V2.

When the update of the dictionary has been established, the dictionary-difference extracting unit 16 refers to the versions V1 and V2 of the dictionary via the dictionary managing unit 14 and extracts the differences (i.e., the updated attributes). The updated-attribute managing unit 17 stores the updated attributes into the updated-attribute storing unit 18. Examples of the stored updated attributes are shown in FIG. 7.

Further, as shown in FIG. 8, the instances generated according to the dictionary V1 are carried over, as they are, into the dictionary V2. By using the flags (Flg), the old/new-flag managing unit 19 manages the version of the dictionary (i.e., V1 or V2) according to which each of the instances has been edited. The instances that are edited after the update of the dictionary has been established are considered as instances that are edited according to the dictionary V2. Thus, the flags of these instances indicate V2. In FIG. 8, the part number: X_C0010 and the part number: Y_C0020 are the instances generated according to the dictionary V2.

Next, a search-result display function achieved by the constituent elements of the server 1 that serves as the data displaying apparatus will be explained in detail.

A searcher uses the client terminal 3 that functions as the searcher terminal and inputs a search criterion. When having received the search criterion that has been input, the search-criterion input unit 22 forwards the received search criterion to the instance managing unit 15. The instance managing unit 15 searches through the instance unit 11b included in the hierarchical database 11 based on the search criterion and forwards a search result to the search-result output unit 23.

In the present example, it is assumed that “obtain all the instances that belong to capacitors (C3)” is specified as a search criterion. A result obtained by performing a search through the instance unit 11b included in the hierarchical database 11 based on this search criterion via the instance managing unit 15 is shown in FIG. 10.

Subsequently, the search-result output unit 23 determines a display mode in which the search result received from the instance managing unit 15 is to be displayed on the client terminal 3 functioning as the searcher terminal. More specifically, if the search result contains one or more instances that are written according to the old version of the dictionary, namely the dictionary V1, for each of the properties of the instances (i.e., for each cell), the display judging unit 23a included in the search-result output unit 23 determines a display method used in the cell, based on the information obtained from the attribute managing unit 17 and the display-mode-rule managing unit 20.

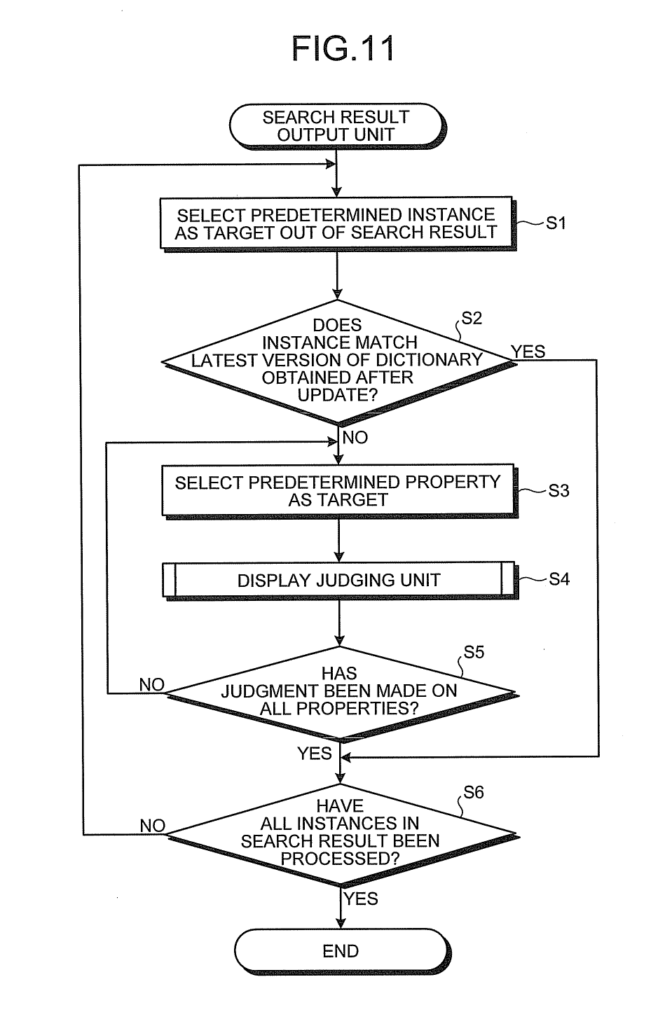

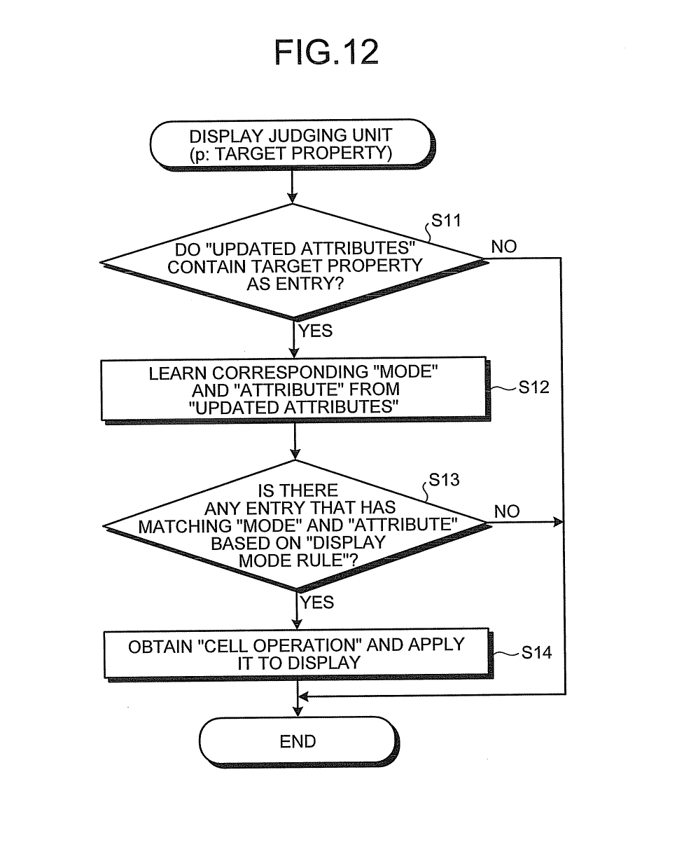

The display method judging process performed by the search-result output unit 23 will be explained with reference to flowcharts in FIGS. 11 and 12. As shown in FIG. 11, a predetermined instance is selected, as a target, out of the search result received from the instance managing unit 15 (step S1). Next, it is judged if the instance matches the latest version of the dictionary obtained after the update (step S2). If it has been judged that the instance matches the latest version of the dictionary (step S2: Yes), the process returns to step S1 where another instance is selected as a target. If it has been judged that the instance does not match the latest version of the dictionary (step S2: No), a predetermined property of the instance is selected (step S3), and the display judging unit 23a performs the process (step S4).

The judging process performed by the display judging unit 23a at step S4 is repeated until judgment is made (step S5: Yes) on each of all the properties of the instance that has been judged, at step S2, not to match the latest version of the dictionary obtained after the update.

The process at steps S1 through S5 explained above is repeated until all the instances in the search result have been processed (step S6: Yes).

As shown in FIG. 12, the judging process performed by the display judging unit 23a at step S4 is to use the target property selected at step S3 shown in FIG. 11 as an input and to judge whether the updated-attribute managing unit 17 contains the target property as an entry (step S11). If it has been judged that the target property is not contained as an entry (step S11: No), the process at step S4 ends. On the other hand, if it has been judged that the target property is contained as an entry (step S1: Yes), corresponding “mode” and “attribute” are learned from the updated-attribute managing unit 17 (step S12). Subsequently, it is judged whether there is an entry that has matching “mode” and “attribute”, based on the display mode rule managed by the display-mode-rule managing unit 20 (step S13). If it has been judged that there is no matching entry (step S13: No), the process at step S4 ends. On the other hand, if it has been judged that there is a matching entry (step S13: Yes), the “cell operation” of the entry is obtained, and the operation is applied to the display of the corresponding cell (step S14), and the process at step S4 ends.

Next, the display method judging process will be explained more specifically, using the search result shown in FIG. 10. The following explanation will be based on an example in which the instance in the first line in FIG. 10 is selected at step S1 in FIG. 11. The latest version of the dictionary that is obtained after the update and is managed by the hierarchical database 11 is V2. Thus, the Flg=V1 of the instance does not match the latest version (step S2: No). Accordingly, the process proceeds to step S3, where a target property is selected. In the present example, it is assumed that “P1: manufacturer name” in the first column is selected as the target property.

Next, at step S4, it is checked to see if there is an entry with P1, based on the updated attributes shown in FIG. 7 (step S11). Because the definition of P1 has been changed, it is judged that there is an entry (in the first line) (step S11: Yes). It is learned that “mode=MOD” and “attribute=DEF” (step S12). After that, it is checked to see if the display mode rule shown in FIG. 9 contains any entry that has “mode=MOD” and “attribute=DEF” (step S13). In the display mode rule shown in FIG. 9, there is such an entry in the second line (step S13: Yes). Because the cell operation is defined as “setBackground (“yellow”)”, the background is set to yellow when the cell for P1 of the instance is displayed (step S14).

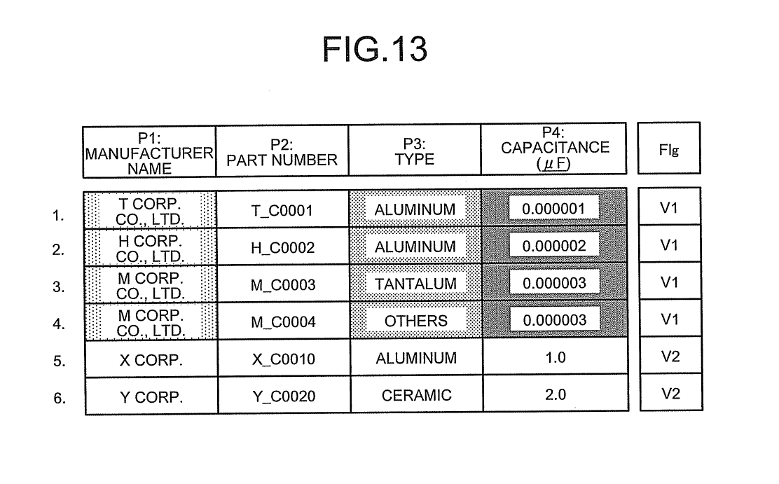

As explained above, the display judging process at step S4 is performed on each of all the properties of all the instances in the search result. The result of the display judging process is shown in FIG. 13.

As shown in FIG. 13, as a result of the process described above, the display of the instances that are written according to the new version V2 of the dictionary and the display of the cells for the properties of which the attribute has not been changed remain unchanged.

When a dictionary has been updated, if two or more items of attributes of a property are changed at the same time, the behavior is determined according to a priority level of the display mode rule. For example, an entry on the upper level may be prioritized.

In the description of the first embodiment, the example is used in which the background color is changed; however, it is acceptable to define the operation for the cell display so that the font used in the foreground is changed.

As explained above, when the dictionary is updated, if the “unit” or the “definition” has been changed, the background color of the cell or the like is changed. Thus, it is possible to indicate to the searcher that he/she needs to pay attention to the value.

Next, the significance of changing the background color when an enumeration type (Enum) has been added will be additionally explained. For example, the value of P3 in the fourth line in FIG. 13 is “others”, which is the enumeration type (Enum) according to the old version V1 of the dictionary. If this item actually corresponds to “ceramic”, which is introduced in the new version V2 of the dictionary, it is not appropriate to keep it as “others” according to the new version V2 of the dictionary. Thus, there is significance in drawing the searcher's attention by changing the background color when an ENUM element has been added.

As explained above, according to the first embodiment, the display mode of the instances that are generated based on the old version of the dictionary and are related to the types of attributes that have been updated is determined according to the display mode rule defining that the display mode for the instances generated based on the old version of the dictionary is different from the display mode for the instances generated based on the new version of the dictionary. The instances that are generated based on the old version of the dictionary are displayed together with the instances generated based on the new version of the dictionary. For example, when a part of properties is updated (e.g. the attribute “unit” of a property is changed from “centimeters [cm]” to “meters [m]”), the display mode is changed so that the searcher is informed that although the dictionary has been revised, not all the instances are necessarily written based on the new version of the dictionary. With this arrangement, when both the old and the new versions of the dictionary/instances are managed, and if the instance editor on the part information supplier side keeps using the instances that are written according to the old version of the dictionary, it is possible to display the search result in such a manner that does not mislead by the searcher. In addition, when a dictionary has been updated, the instance editor on the part information supplier side does not need to rush to update the instances. Thus, after the dictionary has been updated, it is possible to manage the instances in a relaxed manner.

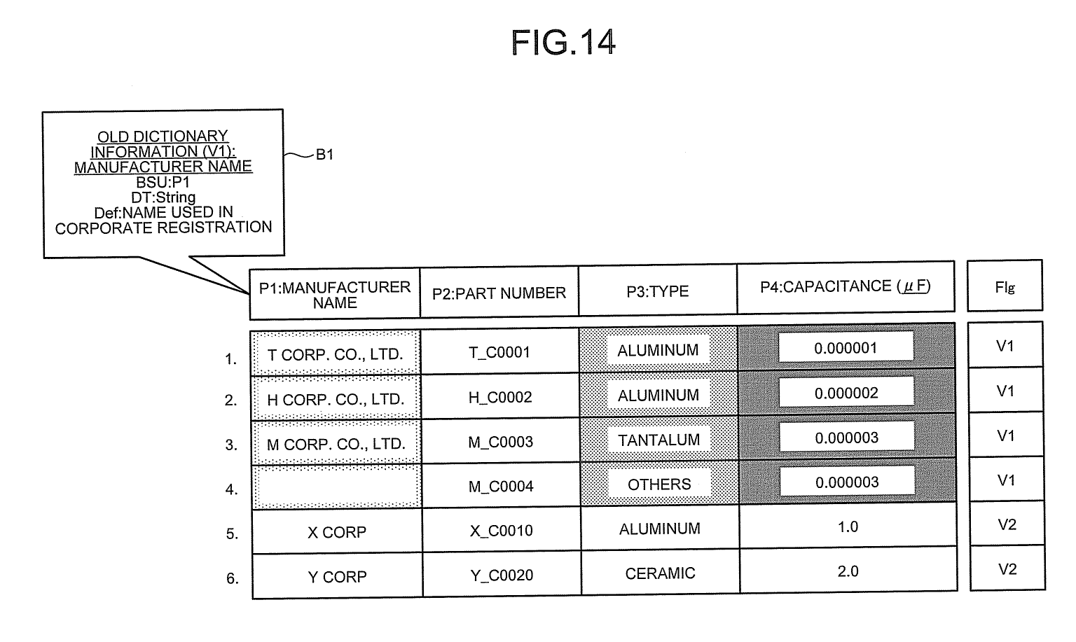

As shown in FIG. 14, it is acceptable to add a function of displaying old dictionary information in a pop-up window or the like, together with a cell of which the cell operation has been changed. In FIG. 14, an example is shown in which when a cursor is placed on the property value of P1 of the instance in the first line, the attributes of the property defined based on the old version V1 of the dictionary are displayed in a balloon B1. When this function is added, the viewer is able to refer to the old version of the dictionary easily.

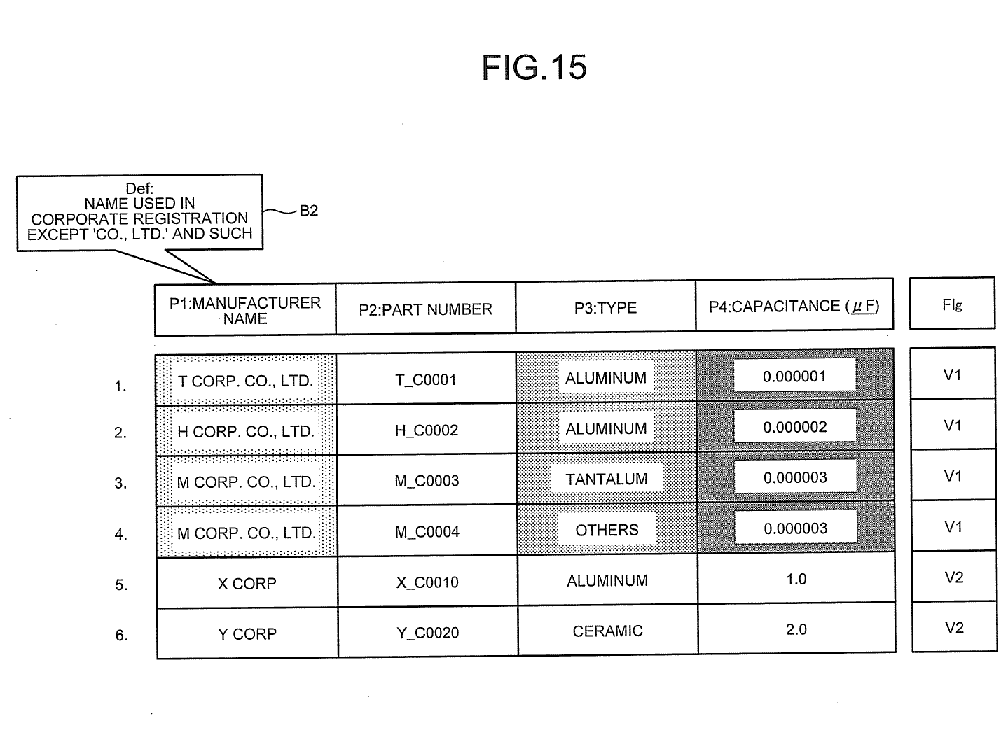

Also, as shown in FIG. 15, it is also acceptable to add another function of displaying new dictionary information in a pop-up window or the like, together with a cell of which the cell operation has been changed. In FIG. 15, an example is shown in which when a cursor is placed on the property value of P1 of the instance in the first line, the attributes of the property defined based on the new version V2 of the dictionary are displayed in a balloon B2. When this function is added, the viewer is able to refer to the new version of the dictionary easily.

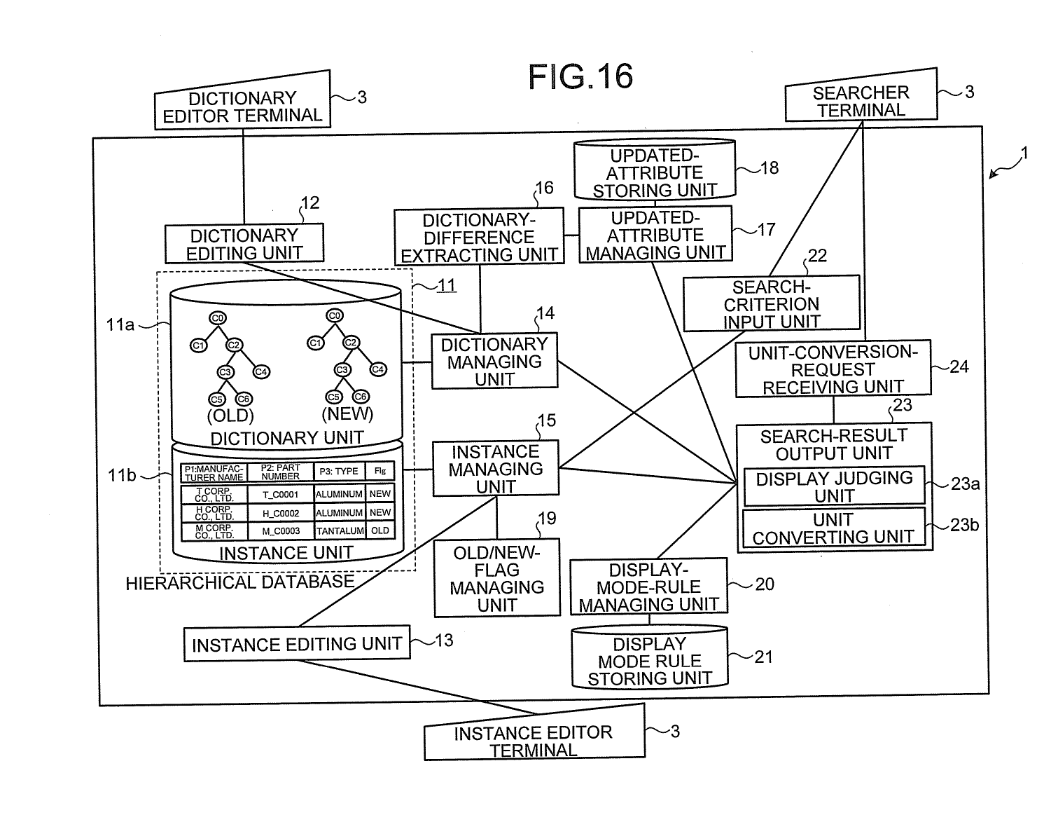

Next, a second embodiment will be explained with reference to FIGS. 16 to 18. The constituent elements that are the same as those in the first embodiment will be referred to by using the same reference characters, and the explanation thereof will be omitted.

In the description of the first embodiment, the example has been explained in which, when a unit (UNIT) is changed, the background color of the cell is changed, but the value is kept as it is. According to the second embodiment, when a unit (UNIT) is changed, the value is automatically converted.

As shown in FIG. 16, the server 1 that is included in a data search-displaying system according to the second embodiment is different from the one shown in FIG. 3 in that the server 1 includes a unit-conversion-request receiving unit 24 as a result of operation according to the search-displaying process program. Also, the search-result output unit 23 includes a unit converting unit 23b that has a function of converting units.

When there is an instance that is written according to the old version of the dictionary and of which the unit used in the new version of the dictionary is different from the unit used in the old version of the dictionary, the unit-conversion-request receiving unit 24 receives a search request from the client terminal 3 that functions as a searcher terminal and instructs the unit converting unit 23b included in the search-result output unit 23 to convert the unit for the value of the corresponding property.

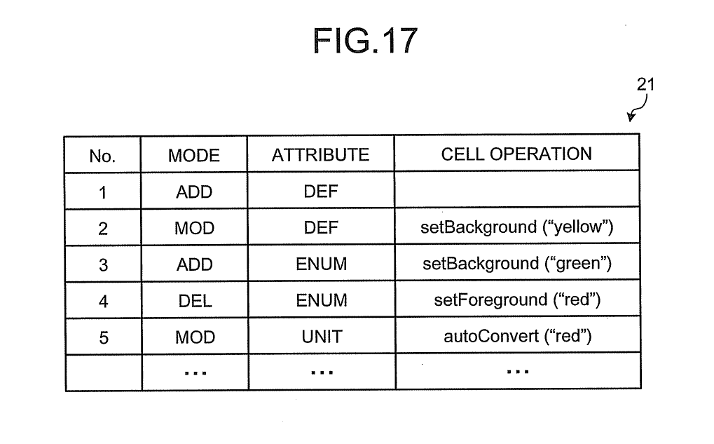

Further, as shown in FIG. 17, a display mode rule according to the second embodiment is different from the display mode rule shown in FIG. 9 in that the cell operation according to the rule No. 5 is indicated as autoConvert (“red”), which means an automatic conversion.

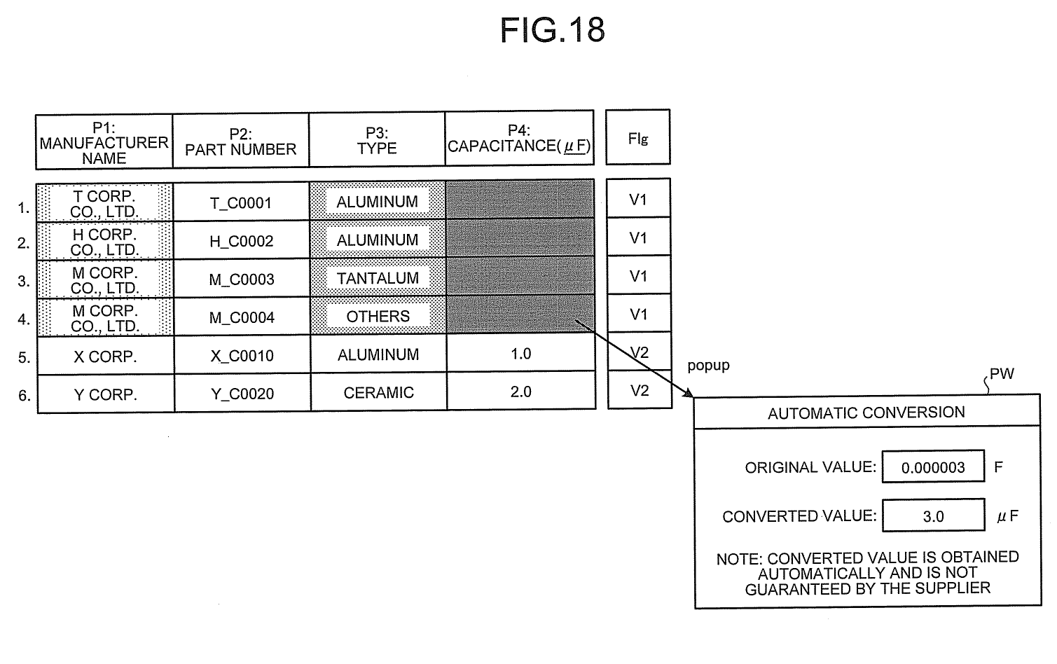

With this arrangement, the background color of a cell to which the cell operation according to the rule No. 5 is applied is red. When a trigger is received from a searcher via the unit-conversion-request receiving unit 24, the unit system according to the old version V1 of the dictionary is converted into the unit system according to the new version V2 of the dictionary by the unit converting unit 23b, and the search result is displayed by the search-result output unit 23. In FIG. 18, an example is shown in which the value obtained after the automatic conversion is presented in a pop-up window PW.

As explained above, according to the second embodiment, because the function of automatically converting the unit according to a request from a user received via the unit-conversion-request receiving unit 24 is added, it is possible to improve the level of reliability in the data conversion.

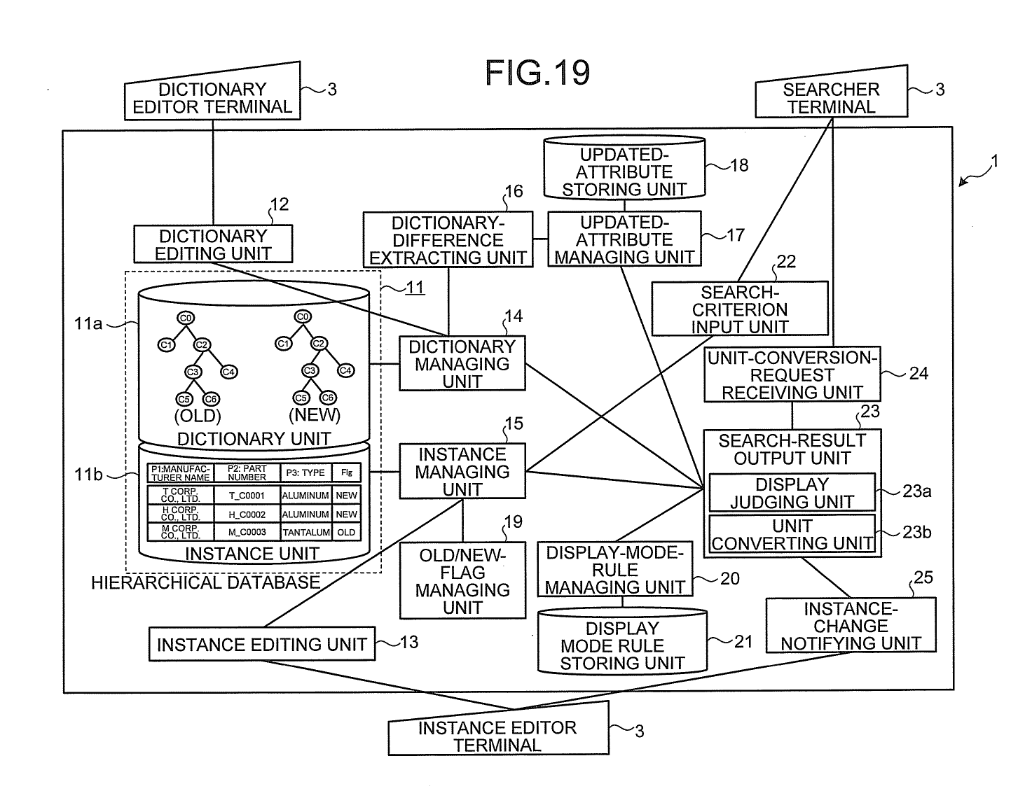

Next, a third embodiment will be explained with reference to FIGS. 19 to 21. The constituent elements that are the same as those in the first embodiment or the second embodiment will be referred to by using the same reference characters, and the explanation thereof will be omitted.

According to the third embodiment, if a searcher is a user who has authority to edit instances, and when a search result contains one or more instances that are written according to the old version of the dictionary, a request demanding that the values of the instances should be changed (i.e., that the instances should be updated with instances written according to the dictionary V2) is issued.

As shown in FIG. 19, the server 1 that is included in a data search-displaying system according to the third embodiment is different from the one shown in FIG. 16 in that the server 1 includes an instance-change notifying unit 25 as a result of operation according to the search-displaying process program.

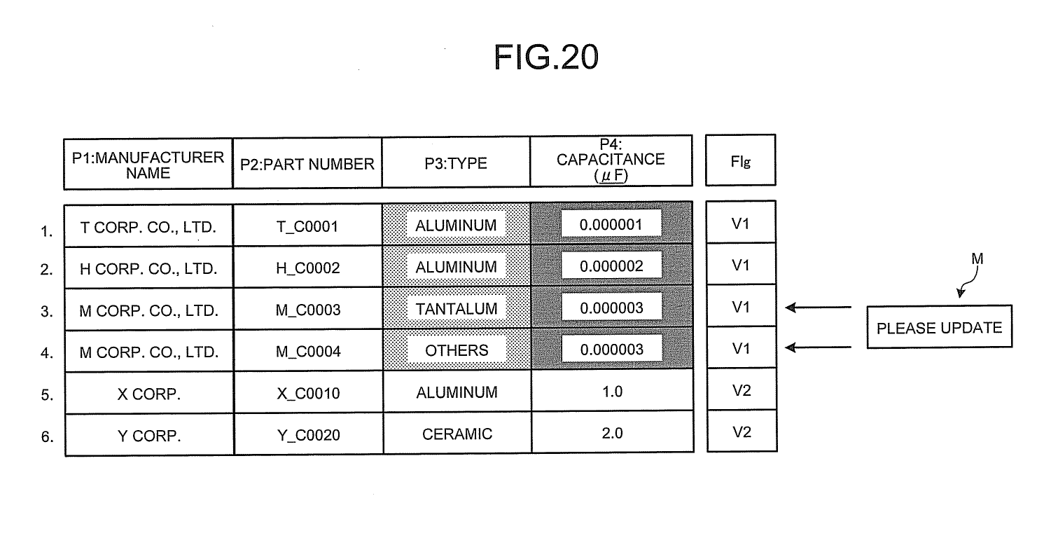

When an operator, using the client terminal 3 that functions as an instance editor terminal on the part information supplier side, is an instance editor that has authority to edit instances, the instance change notifying unit 25 achieves the function of issuing a notification suggesting that the one or more instances written according to the old version of the dictionary should be updated. The notification suggesting the update may be, for example, a message M saying “Please update.” as shown in FIG. 20.

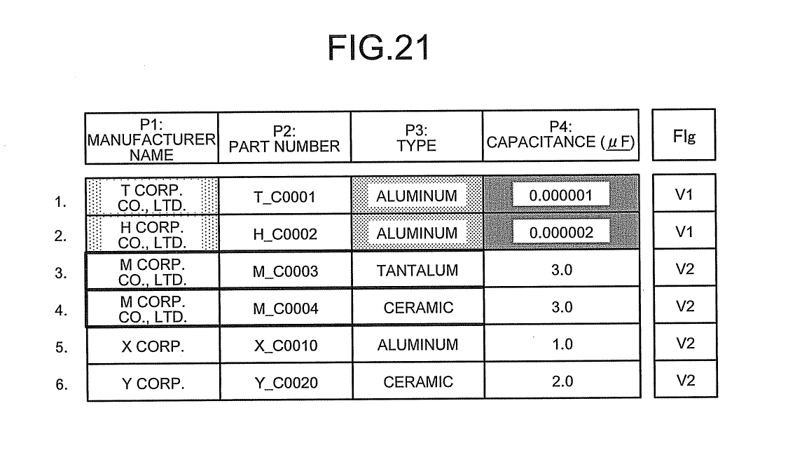

FIG. 21 shows a state obtained after a user who has authority to edit instances of M Corporation Co., Ltd. has received a notification from the instance change notifying unit 25 and has edited the instances in the third and the fourth lines. As shown in FIG. 21, because the flags (Flg) of these instances are updated to V2 by the old/new-flag managing unit 19, the display mode rule is not applied to these instances.

As explained above, according to the third embodiment, if a searcher is a user who has authority to edit instances, and when a search result contains one or more instances that are written according to the old version of the dictionary, the instance change notifying unit 25 is capable of requesting that the values of the instances should be changed (i.e., that the instances should be updated with instances written according to the dictionary V2).

The description of the first, the second, and the third embodiments is based on the example in which a server-client system is used; however, the present invention is not limited to this example. It is acceptable to apply the present invention to a stand-alone system that is not connected to a network.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data displaying apparatus comprising:
an instance data managing unit that manages an old version of an instance data and a new version of the instance data that are respectively generated based on an old version of a dictionary and a new version of the dictionary, the dictionary having the old and the new versions due to a change in a property, the attribute being detailed information field defining a characteristic of the property;
an updated-attribute extracting unit that extracts an updated attribute resulting from an update of an attribute between the old version of the dictionary and the new version of the dictionary;
a display-mode-rule managing unit that manages a display mode rule defining so that a display mode for the old version of the instance data is different from a display mode for the new version of the instance data, according to the updated attribute;
a searching unit that searches the instance data according to a search request, the instance data generated based on the old version of the dictionary; and
a displaying unit that displays the instance data in the display mode that is different from the display mode in which the instance data generated based on the new version of the dictionary is displayed, according to the updated attribute extracted by the updated-attribute extracting unit and the display mode rule managed by the display-mode-rule managing unit.

2. The apparatus according to claim 1, wherein
the displaying unit displays the attribute of the property defined by the old version of the dictionary, in correspondence with the instance data generated based on the old version of the dictionary.

3. The apparatus according to claim 1, wherein
the displaying unit displays the attribute of the property defined by the new version of the dictionary, in correspondence with the instance data generated based on the old version of the dictionary.

4. The apparatus according to claim 1, wherein
the updated attribute is an item indicating a “definition” of the property.

5. The apparatus according to claim 1, wherein
the updated attribute is an item indicating a “unit” of the property.

6. The apparatus according to claim 1, wherein
the updated attribute is an item indicating an “enumerated value” of the property.

7. The apparatus according to claim 5, further comprising:
a unit-conversion-request receiving unit that instructs that the unit should be converted with regard to a value of the property of the instance data generated based on the old version of the dictionary, when the search result contains the instance data generated based on the old version of the dictionary and a unit used in the new version of the dictionary is different from a unit used in the old version of the dictionary; and
a unit converting unit that converts the unit that is different between the old version of the dictionary and the new version of the dictionary, with regard to the value of the property for which the unit conversion instruction is received, according to the display mode rule managed by the display-mode-rule managing unit, wherein
the displaying unit displays the value of which the unit is converted, in correspondence with the instance data generated based on the old version of the dictionary.

8. The apparatus according to claim 1, further comprising:
an instance data change notifying unit that issues a request that the instance data should be changed to the instance data generated based on the new version of the dictionary, when the search result contains the instance data generated based on the old version of the dictionary.

9. A computer program product having a computer readable medium including programmed instructions, wherein the instructions for performing data search, when executed by a computer, cause the computer to perform:
managing an old version of an instance data and a new version of the instance data that are respectively generated based on an old version of a dictionary and a new version of the dictionary, the dictionary having the old and the new versions due to a change in a property, the attribute being detailed information field defining a characteristic of the property;
extracting an updated attribute resulting from an update of an attribute between the old version of the dictionary and the new version of the dictionary;
managing a display mode rule defining that a display mode for the old version of the instance data is different from a display mode for the new version of the instance data, according to the updated attribute;
searching the instance data according to a search request, the instance data generated based on the old version of the dictionary; and
displaying the instance data in the display mode that is different from the display mode in which the instance data generated based on the new version of the dictionary is displayed, according to the extracted updated attribute and the managed display mode rule.

10. A data search displaying method comprising:
accepting an input of an instance data that is specific information of a property and is written according to a dictionary;
managing an old version of the instance data and a new version of the instance data that are input and respectively generated based on an old version of the dictionary and a new version of the dictionary, the dictionary having the old and the new versions due to a change in the property, the attribute being detailed information field defining a characteristic of the property;
extracting an updated attribute resulting from an update of an attribute between the old version of the dictionary and the new version of the dictionary;
managing a display mode rule defining that a display mode for the old version of the instance data is different from a display mode for the new version of the instance data, according to the updated attribute;
accepting an input of a search request for a search through the instance data;
searching the instance data according to the input search request, the instance data generated based on the old version of the dictionary; and
displaying the instance data in the display mode that is different from the display mode in which the instance data generated based on the new version of the dictionary is displayed, according to the extracted updated attribute and the managed display mode rule.
